(19) United States
(12) Patent Application Publication
(10) Pub. No.: US 2025/0228218 A1
(43) Pub. Date: Jul. 17, 2025

(54) GAS SOLUBILITY GRADIENT FOR NANOBUBBLE GENERATION

(71) Applicant: Moleaer, Inc., Hawthorne, CA (US)

(72) Inventors: Federico Pasini, Redondo Beach, CA (US); Christian Ference, Los Angeles, CA (US)

(21) Appl. No.: 19/016,907

(22) Filed: Jan. 10, 2025

Related U.S. Application Data
(60) Provisional application No. 63/620,640, filed on Jan. 12, 2024.

(51) Int. Cl. A01K 63/04

(52) U.S. Cl. CPC A01K 63/042

(57) ABSTRACT

Provided herein are nanobubble generators that involve a split-manipulate-recombine configuration to produce a high concentration of nanobubbles in a continuous manner. One such nanobubble generator includes (a) an inlet configured to receive a liquid stream comprising dissolved gas; (b) means in communication with the liquid stream configured to manipulate the liquid stream to form a first liquid substream and a second liquid substream in which the solubility of gas in the first liquid substream is different from the solubility of gas in the second liquid substream; (c) a mixer in communication with the first and second liquid substreams configured to combine the first and second liquid substreams to form a discharge stream comprising nanobubbles in a liquid carrier; and (d) an outlet configured to discharge the discharge stream, wherein the discharge stream comprises at least 10⁶ nanobubbles per cm³.

### CLAIM OF PRIORITY

This application claims priority to U.S. Patent Application Ser. No. 63/620,640, filed on Jan. 12, 2024, the entire contents of which are hereby incorporated by reference.

### TECHNICAL FIELD

This disclosure relates to nanobubble generators and methods for generating nanobubbles.

### BACKGROUND

Nanobubbles have long lifetimes in liquid due to their negatively charged surfaces. Nanobubbles also have high gas solubility into liquid due to their high internal pressure, which typically is more than five times greater than atmospheric pressure. Consequently, nanobubbles do not rise to the surface of the liquid.

### SUMMARY

The inventors have discovered that nanobubbles can be generated in a continuous manner by splitting a liquid stream into two liquids steams, creating a gas solubility differential between the two liquid streams, and combining the two liquid streams having the gas solubility differential to produce a nanobubble-containing liquid stream.

Accordingly, aspects of the present disclosure provide a nanobubble generator comprising: (a) an inlet configured to receive a liquid stream comprising dissolved gas; (b) means in communication with the liquid stream configured to manipulate the liquid stream to form a first liquid substream and a second liquid substream in which the solubility of gas in the first liquid substream is different from the solubility of gas in the second liquid substream; (c) a mixer in communication with the first and second liquid substreams configured to combine the first and second liquid substreams to form a discharge stream comprising nanobubbles in a liquid carrier; and (d) an outlet configured to discharge the discharge stream, wherein the discharge stream comprises at least 10⁶ nanobubbles per cm³.

In some embodiments, the first liquid substream and second liquid substream have different temperatures from each other. In some embodiments, the first liquid substream and second liquid substream have different ionic conductivities from each other.

In some embodiments, the means in communication with the liquid stream comprises (a) a stream splitter in communication with the liquid stream configured to separate the liquid stream into a first liquid substream having an ionic conductivity and a second liquid substream having an ionic conductivity; and (b) an ion exchange membrane, resin, or combination thereof in communication with the first liquid substream, the second liquid substream, or both configured to remove ions from the first liquid substream, the second liquid substream, or both to adjust the relative ionic conductivities of the first and second liquid substreams such that the ionic conductivity of the first liquid substream is different from the ionic conductivity of the second liquid substream.

In some embodiments, the means in communication with the liquid stream comprises a membrane configured to separate the liquid stream into a first liquid substream having an ionic conductivity and a second liquid substream having an ionic conductivity that is different from the ionic conductivity of the first liquid substream.

In some embodiments, the membrane is selected from the group consisting of an ultrafiltration membrane, a nanofiltration membrane, a reverse osmosis membrane, and combinations thereof.

In some embodiments, the means in communication with the liquid stream comprises (a) a stream splitter in communication with the liquid stream configured to separate the liquid stream into a first liquid substream having an ionic conductivity and a second liquid substream having an ionic conductivity; and (b) a salt source in communication with the first liquid substream, the second liquid substream, or both configured to introduce salt into the first liquid substream, the second liquid substream, or both to adjust the relative ionic conductivities of the first and second liquid substreams such that the ionic conductivity of the first liquid substream is different from the ionic conductivity of the second liquid substream.

In some embodiments, the means in communication with the liquid stream comprises (a) a stream splitter in communication with the liquid stream configured to separate the liquid stream into a first liquid substream and a second liquid substream; and (b) a source of a solubilty agent in communication with the first liquid substream, the second liquid substream, or both configured to introduce the solubility agent into the first liquid substream, the second liquid substream, or both. For instance, the solubility agent can include one or more of a salt, an acid, a base, an organic additive, or a polymer.

Aspects of the present disclosure provide an apparatus comprising (a) an aquarium; and (b) a nanobubble generator described herein configured to introduce the discharge stream comprising nanobubbles in a liquid carrier into the aquarium.

Aspects of the present disclosure provide an apparatus comprising (a) an irrigation system; and (b) a nanobubble generator described herein configured to introduce the discharge stream comprising nanobubbles in a liquid carrier into the irrigation system.

Aspects of the present disclosure provide a method for generating nanobubbles comprising (a) providing a liquid stream comprising dissolved gas; (b) manipulating the liquid stream to form a first liquid substream and a second liquid substream in which the solubility of gas in the first liquid substream is different from the solubility of gas in the second liquid substream; and (c) combining the first and second liquid substreams to form a discharge stream comprising nanobubbles in a liquid carrier, wherein the discharge stream comprises at least 10⁶nanobubbles per cm³.

In some embodiments, manipulating the liquid stream comprises manipulating the liquid stream such that the first liquid substream and second liquid substream have different temperatures, different ionic conductivities, or a combination thereof from each other.

### BRIEF DESCRIPTION OF THE DRAWINGS

FIG. 1 is a schematic illustration of an example nanobubble generator.

FIG. 2 is a schematic illustration of a second example nanobubble generator.

FIG. 3 is a schematic illustration of a third example nanobubble generator.

FIG. 4 is a schematic illustration of a fourth example nanobubble generator.

FIG. 5 is a flow chart showing a method for generating nanobubbles according to some embodiments described herein.

FIG. 6 is a graph showing nanobubble production in a nanobubble generator recirculating a static volume of liquid. Production is calculated as the differential between cycle 0 and subsequent cycles.

### DETAILED DESCRIPTION

Following below are more detailed descriptions of various concepts related to, and exemplary embodiments of, inventive nanobubble generators, apparatuses including the nanobubble generators, and methods for generating nanobubbles using the nanobubble generators. Provided herein are continuous flow, flow-through nanobubble generators that involve a split-manipulate-recombine configuration in which a liquid stream is split into two substreams, one or both of the substreams is manipulated to create a gas solubility differential between the substreams, and then the substreams are recombined to generate a high concentration of nanobubbles (e.g., at least 10⁶ nanobubbles per cm³). Because of the difference in gas solubilities between the substreams, upon recombination, a high concentration of nanobubbles is generated. In some examples, substreams with different gas solubilities can be created by manipulating the substreams to have different temperatures from each other and/or different conductivities (e.g., ionic conductivities) from each other. For instance, substreams with different gas solubilities can be created by introducing a solubility agent into one or both substreams. Examples of solubility agents include a salt, an acid, a base, an organic additive, or a polymer. Also provided herein are methods that involve a split-manipulate-recombine approach for generating nanobubbles from a gas solubility differential.

As used herein, the term “nanobubble” refers to a bubble that has a diameter of less than one micron. A microbubble, which is larger than a nanobubble, is a bubble that has a diameter greater than or equal to one micron and smaller than 50 microns. A macrobubble is a bubble that has a diameter greater than or equal to 50 microns. As used herein, a “nanobubble generator” refers to a device for generating nanobubbles.

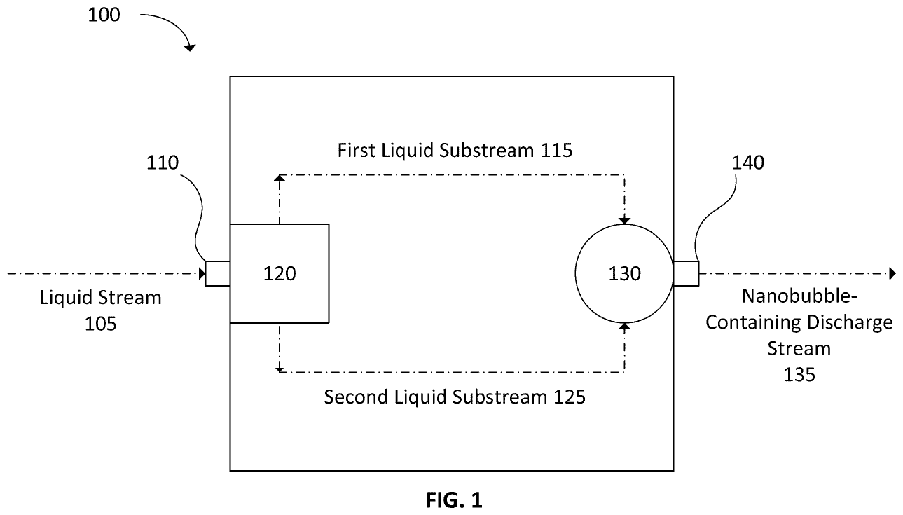

FIG. 1 shows an exemplary nanobubble generator 100 that includes an inlet 110 for receiving a liquid stream 105, a means in communication with the liquid stream 120, a mixer 130, and an outlet 140. The inlet 110 is configured to receive a liquid stream 105 including dissolved gas. The liquid can include water, another liquid such as an organic solvent, or a combination thereof. The means 120 is configured to receive the liquid stream 105 from the inlet 110 and separates the liquid stream 105 into a first liquid substream 115 and a second liquid substream 125, each of which has a different solubility of gas. For instance, the means 120 can include an element configured to adjust a temperature and/or a conductivity (e.g., an ionic conductivity) of one or both of the substreams 115, 125. Because gas solubility varies with temperature and with conductivity, the gas solubility differs between streams having different temperatures and/or different conductivities.

As shown in FIG. 1, the mixer 130 receives both the first liquid substream 115 and the second liquid substream 125 and combines the first liquid substream 115 and the second liquid substream 125 to form a nanobubble-containing discharge stream 135. Because of the gas solubility differential between the first liquid substream 115 and the second liquid substream 125, upon recombination by mixer 130, a high concentration of nanobubbles is generated in discharge stream 135. The outlet 140 is configured to discharge the nanobubble-containing discharge stream 135.

In some embodiments, the means 120 includes a membrane configured to separate the liquid stream into a first liquid substream having an ionic conductivity and a second liquid substream having an ionic conductivity that is different from the ionic conductivity of the first liquid substream. For instance, the first liquid substream 115 can be a higher ionic conductivity reject stream from the membrane and the second liquid stream 125 can be a lower ionic conductivity permeate stream from the membrane. Non-limiting examples of a membrane for use in a nanobubble generator described herein include an ultrafiltration membrane, a nanofiltration membrane, a reverse osmosis membrane, and a combination of any of these.

Nanobubble generators described herein are capable of continuous generation of nanobubbles as liquid flows through the device. For example, in FIG. 1, the liquid stream 105 is continuously flowed through the nanobubble generator 100 to continuously produce the nanobubble-containing discharge stream 135.

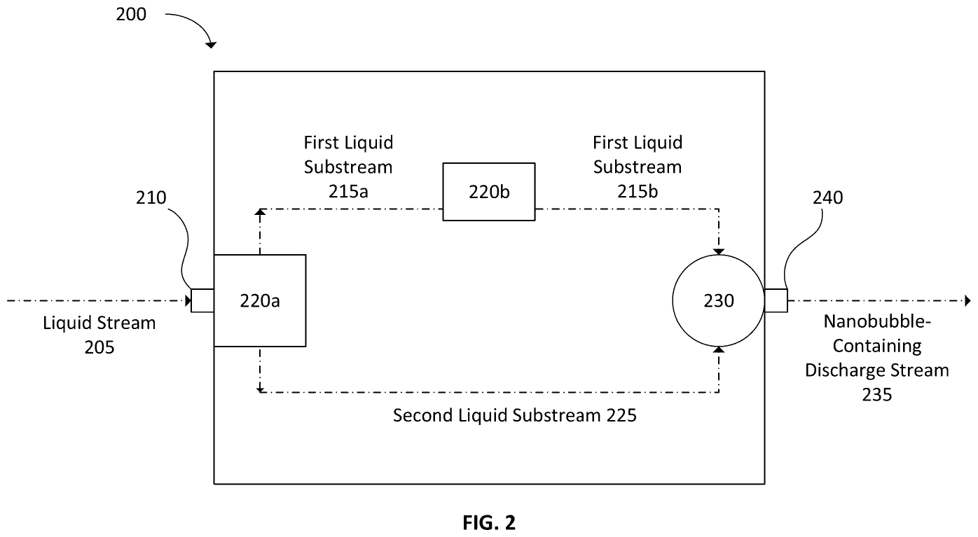

FIG. 2 shows an exemplary nanobubble generator 200 in which the means in communication with the liquid stream includes a stream splitter 220a and an ion exchange element 220b, such as an ion exchange membrane, a resin, or a combination thereof. The ion exchange element 220b is configured to adjust the relative ionic conductivities of the liquid substreams flowing through the nanobubble generator 200 to thereby adjust the gas solubility in one or both substreams. As shown in FIG. 2, the stream splitter 220a is configured to receive a liquid stream 205 including dissolved gas from an inlet 210 and to separate the liquid stream 205 into a first liquid substream 215a and a second liquid substream 225, each of which has an ionic conductivity. In the example of FIG. 2, the ion exchange element 220b is in communication with the first liquid stream 215a and is configured to adjust the ionic conductivity of the first liquid stream 215b, for instance, by removing ions from the first liquid substream 215a, such that the ionic conductivity of the first liquid substream 215b is different from the ionic conductivity of the second liquid substream 225. Alternatively, or in addition, the nanobubble generator 200 can include an ion exchange element, such as a membrane, resin, or combination thereof, that is in communication with the second liquid substream 225 and is configured to adjust the relative ionic conductivities of the second liquid substream 225, for instance, by removing ions from the second liquid substream 225, such that the ionic conductivity of the second liquid substream 225 is different from the ionic conductivity of the first liquid substream 215b.

As shown in FIG. 2, the mixer 230 receives both the first liquid substream 215b and the second liquid substream 225 and combines them to form a nanobubble-containing discharge stream 235. Because the ionic conductivity between the first liquid substream 215b and the second liquid substream 225 is different, the gas solubility between the substreams is different, and thus recombination of the substreams by mixer 230 produces a high concentration of nanobubbles in discharge stream 235. The outlet 240 is configured to discharge the nanobubble-containing discharge stream 235.

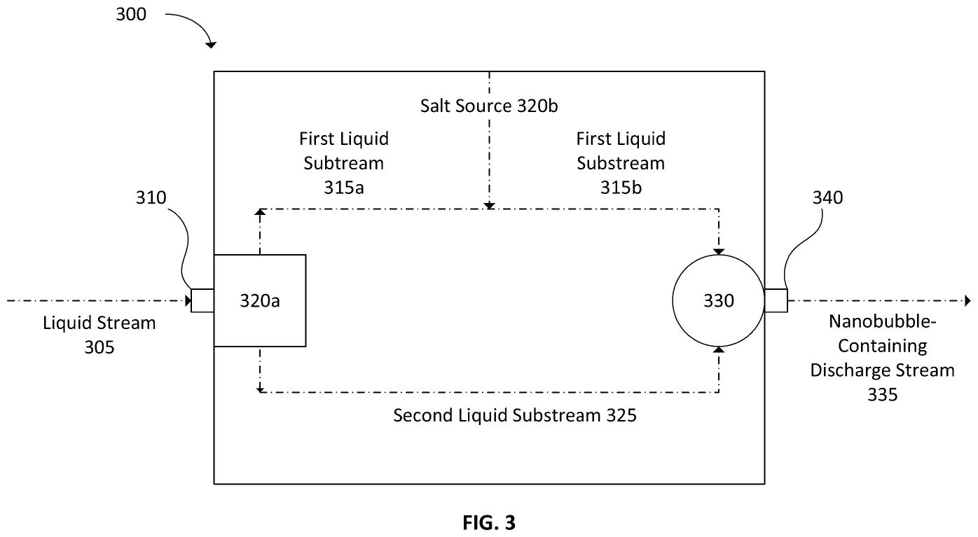

FIG. 3 shows an exemplary nanobubble generator 300 in which the means in communication with the liquid stream includes a stream splitter 320a and a salt source 320b. Introduction, by the salt source 320b, of salt into one of the liquid substreams flowing through the nanobubble generator 300 causes the relative ionic conductivities of the liquid substreams to differ, thereby also causing the gas solubility to differ between the two substreams. As shown in FIG. 3, the stream splitter 320a is configured to receive a liquid stream 305 including dissolved gas from an inlet 310 and to separate the liquid stream 305 into a first liquid substream 315a and a second liquid substream 325, each of which has an ionic conductivity. In the example of FIG. 3, the salt source 320b is in communication with the first liquid stream 315a. The salt source is configured to introduce a salt into the first liquid substream 315a to adjust the ionic conductivity of the first liquid substream 315a relative to that of the second liquid substream 325. For instance, addition of salt into the first liquid substream 315a increases the ionic conductivity of the first liquid substream 315a such that the ionic conductivity of the first liquid substream 315b is different from the ionic conductivity of the second liquid substream 325. Alternatively, or in addition, the nanobubble generator 300 can include a salt source that is configured to introduce a salt into the second liquid substream 325 to adjust the ionic conductivity of the second liquid substream 325. The salt can include, e.g., an electrolyte such as a chloride salt, phosphate salt, sulfate salt, or nitrate salt.

As shown in FIG. 3, the mixer 330 receives both the first liquid substream 315b and the second liquid substream 325 and combines them to form a nanobubble-containing discharge stream 335. Because the ionic conductivity between the first liquid substream 315b and the second liquid substream 325 is different, the gas solubility between the substreams is different, and thus recombination of the substreams by mixer 330 produces a high concentration of nanobubbles in discharge stream 335. The outlet 340 is configured to discharge the nanobubble-containing discharge stream 335.

In the example of FIG. 3, the salt acts as a solubility agent that modifies the gas solubility of the first liquid substream. In some examples, a solubility agent other than salt can be introduced into the first liquid substream 315a to modify the gas solubility of the first liquid substream, e.g., by way of a solubility agent source that is in communication with the first liquid stream 315a. Solubility agents that can modify gas solubility include, e.g., acids (e.g., mineral acids such as hydrochloric acid or sulfuric acid), bases (e.g., potassium hydroxide or amines), organic additives (e.g., soluble polar organics such as organic acids, organic bases, alcohols, or ketones; or non-conductive organics such as sugars), polymers (e.g., soluble polymers such as polyvinyl alcohol/acetate, polyelectrolytes, or glycols). In some embodiments, the addition of a solubility agent to a substream modifies the conductivity of the substream, while in other embodiments, the addition of a solubility agent to a substream does not modify the conductivity of the substream.

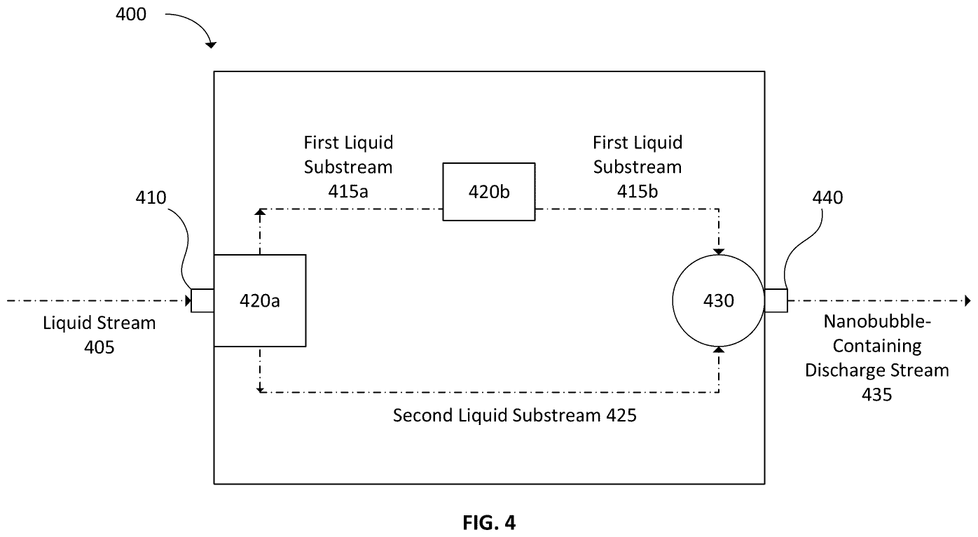

FIG. 4 shows an exemplary nanobubble generator 400 in which the means in communication with the liquid stream includes a stream splitter 420a and a temperature device 420b, such as a heater, a cooler, or a device capable of both heating and cooling. The temperature device 420b is configured to adjust the temperature of the liquid substreams flowing through the nanobubble generator 400 to thereby adjust the gas solubility in one or both substreams. As shown in FIG. 4, the stream splitter 420a is configured to receive a liquid stream 405 including dissolved gas from an inlet 410 and to separate the liquid stream 405 into a first liquid substream 415a and a second liquid substream 425, each of which has a temperature. In the example of FIG. 4, the temperature device 420b is in communication with the first liquid stream 415a and is configured to adjust the temperature of the first liquid stream 415b, for instance, by increasing or decreasing the temperature of the first liquid substream 415a, such that the temperature of the first liquid substream 415b is different from the temperature of the second liquid substream 425. Alternatively, or in addition, the nanobubble generator 400 can include a temperature device, such as a heater, a cooler, or a device capable of both heating and cooling, that is in communication with the second liquid substream 425 and is configured to adjust the relative temperature of the second liquid substream 425, for instance, by increasing or decreasing the temperature of the second liquid substream 425, such that the temperature of the second liquid substream 425 is different from the temperature of the first liquid substream 415b.

As shown in FIG. 4, the mixer 430 receives both the first liquid substream 415b and the second liquid substream 425 and combines them to form a nanobubble-containing discharge stream 435. Because the temperature of the first liquid substream 415b and the second liquid substream 425 is different, the gas solubility between the substreams is different, and thus recombination of the substreams by mixer 430 produces a high concentration of nanobubbles in discharge stream 435. The outlet 440 is configured to discharge the nanobubble-containing discharge stream 435.

Any of the nanobubble generators described herein can include two or more liquid substreams. In such instances, the means configured to manipulate the liquid stream can form more than two liquid substreams (e.g., 3, 4, 5, 6, or more liquid substreams) and the mixer can be in communication with the two or more liquid substreams and configured to combine the two or more liquid substreams to form a nanobubble-containing discharge stream.

Any of the nanobubble generators described herein can include two or more liquid substreams in which the solubility of gas is different. The solubility of gas in each liquid substream can be different or the solubility of gas in some liquid substreams can be different from the solubility of gas in other liquid substreams. For example, when the means configured to manipulate the liquid stream forms three liquid substreams, the solubility of gas in each of the three liquid substreams can be different. Alternatively, the solubility of gas in the first liquid substream can be different than the solubility of gas in the second and third liquid substreams, and the solubility of gas in the second and third liquid substreams can be the same.

The difference in gas solubility between liquid substreams can be created by manipulating the liquid substreams to have different temperatures, different conductivities (e.g., ionic conductivities), or both different temperatures and different conductivities.

For example, when the means configured to manipulate the liquid stream forms two liquid substreams, the first liquid substream and the second liquid substream can have different temperatures. Alternatively, or in addition to, the first liquid substream and the second liquid substream can have different conductivities (e.g., ionic conductivities).

In another example, when the means configured to manipulate the liquid stream forms more than two liquid substreams, the temperature and/or the conductivities (e.g., ionic conductivities) in each liquid substream can be different or the temperature and/or the conductivity in some liquid substreams can be different from the solubility of gas in other liquid substreams. For example, when the means configured to manipulate the liquid stream forms three liquid substreams, the temperature and/or the conductivities (e.g., ionic conductivities) in each of the three liquid substreams can be different. Alternatively, the temperature and/or the conductivities in the first liquid substream can be different than the temperature and/or the conductivities in the second and third liquid substreams, and the temperature and/or the conductivities in the second and third liquid substreams can be the same.

In yet another example, when the means configured to manipulate the liquid stream forms more than two liquid substreams, a solubility agent is added to one or more of the substreams such that the solubility of gas in each liquid substream is different from the solubility of gas in other liquid substreams. For example, when the means configured to manipulate the liquid stream forms three liquid substreams, a solubility agent is added to one or more of the three substreams such that the solubility of gas in each of the three liquid substreams can be different. Alternatively, the solubility of gas in the first liquid substream can be different than the solubility of gas in the second and third liquid substreams, and the solubility of gas in the second and third liquid substreams can be the same.

A nanobubble generator described herein is capable of generating a high concentration of nanobubbles in a discharge stream. In some embodiments, the nanobubble generator can generate a discharge steam including nanobubbles at a concentration of at least 10⁶ nanobubbles per cm³. In some embodiments, the nanobubble concentration in the discharge stream is at least 10⁷ nanobubbles per cm³, at least 10⁸ nanobubbles per cm³, at least 10⁹ nanobubbles per cm³, at least 10¹⁰ nanobubbles per cm³, or at least 10¹¹ nanobubbles per cm³.

The nanobubble concentration is expressed as nanobubbles per cm³. It is measured by collecting 3 samples from the nanobubble generator and analyzing each sample within 20 minutes after it has been obtained by Nanoparticle Tracking Analysis using a Nanosight NS3000 analyzer available from Malvern PANalytical.

A nanobubble generator described herein can be configured for continuous flow of a liquid (e.g., a liquid stream, a liquid substream, or both) through the nanobubble generator at a high flow rate, e.g., a flow rate of greater than 1 gallon per minute (GPM), greater than 2 GPM, greater than 3 GPM, greater than 4 GPM, greater than 5 GPM, or more.

For example, when an apparatus includes a nanobubble generator and an aquarium, the nanobubble generator can be configured for continuous flow of a liquid (e.g., a liquid stream, a liquid substream, or both) at a flow rate between about 0.5 and about 1.5 GPM, e.g., about 0.5, about 0.6, about 0.7, about 0.8, about 0.9, about 1.0, about 1.1, about 1.2, about 1.3, about 1.4, or about 1.5 GPM. In another example, when an apparatus includes a nanobubble generator and an irrigation system, the nanobubble generator can be configured for continuous flow of a liquid (e.g., a liquid stream, a liquid substream, or both) at a flow rate between about 2 and about 5 GPM, e.g., about 2, about 2.5, about 3, about 3.5, about 4, about 4.5, or about 5 GPM. Nanobubbles for use in methods described herein can include any gas. Non-limiting examples of gases include air, hydrogen, biogas, methane, carbon dioxide, nitrogen, oxygen, or ozone.

Any of the nanobubble generators described herein can be used in a number of applications including agriculture, horticulture, aquaculture, water, wastewater, water treatment, food processing, electrolysis, lakes and ponds, oil and gas, and mining applications. In some embodiments, a nanobubble generator described herein can be included in an apparatus including an aquarium or an irrigation system. In such instances, the nanobubble generator can be configured to introduce the nanobubble-containing discharge stream, optionally in a liquid carrier, into the aquarium or the irrigation system.

The present disclosure also provides methods for generating nanobubbles involving splitting a liquid stream into two liquids steams, creating a gas solubility differential between the two liquid streams, and combining the two liquid streams having the gas solubility differential to produce a nanobubble-containing liquid stream having at least 10⁶ nanobubbles per cm³.

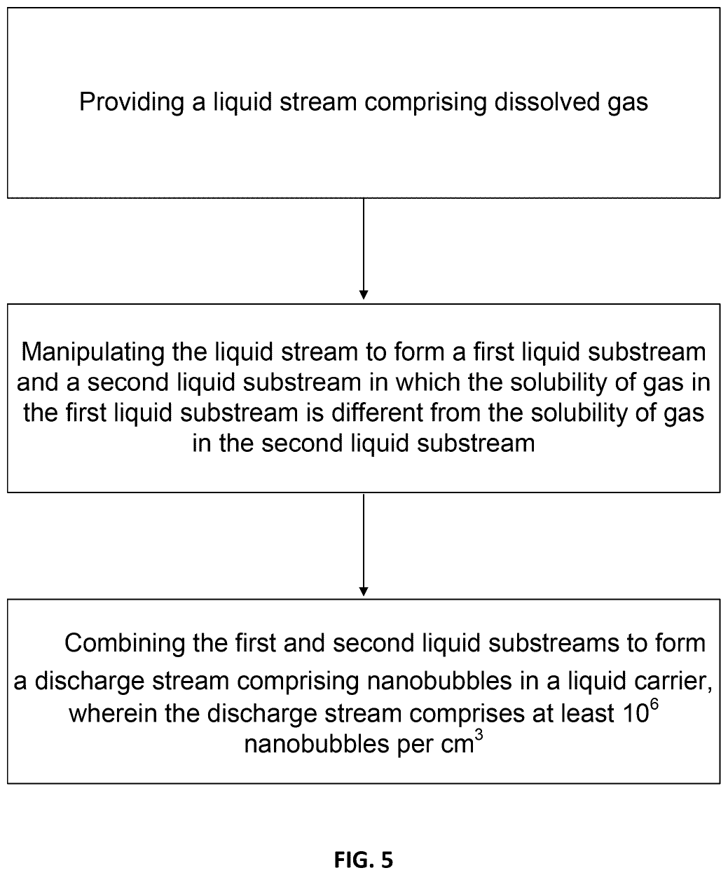

Methods described herein encompass manipulating the liquid stream such that the gas solubility differs between the first liquid substream and the second liquid substrate, e.g., such that the first liquid substream and the second liquid substream have different temperatures, different conductivities (e.g., ionic conductivities), or both different temperatures and different conductivities. These methods can involve introducing a solubility agent to one or both of the liquid substreams, which can result in different conductivities or can result in substreams with the same conductivity but different gas solubilities. When methods involve more than two liquid substreams, the solubility of gas in each liquid substream can be different (e.g., due to differences in temperature and/or conductivity (e.g., ionic conductivity) or the solubility of gas in some liquid substreams can be different from the solubility of gas in other liquid substreams. For example, as shown in FIG. 5, a method for generating nanobubbles described herein includes providing a liquid stream comprising dissolved gas; manipulating the liquid stream to form a first liquid substream and a second liquid substream in which the solubility of gas in the first liquid substream is different from the solubility of gas in the second liquid substream; and combining the first and second liquid substreams to form a discharge stream comprising nanobubbles in a liquid carrier, wherein the discharge stream comprises at least 10⁶ nanobubbles per cm³.

### EXAMPLES

The following examples described in this application are offered to illustrate the methods provided herein and are not to be construed in any way as limiting.

### Example 1: Nanobubble Generation in an Irrigation System

A nanobubble generator described herein was used to generate nanobubbles in an irrigation system. The nanobubble generator included the split-manipulate-recombine configuration as well as a resin and salt source for ionic manipulation.

Nanobubble generation was tested in an inline, single-pass configuration in which the liquid flowing through the nanobubble generator was not recirculated. The liquid stream was treated with a single pass of the split-manipulate-recombine approach, and nanobubble generation was measured in the recombined liquid stream. Nanobubble generation was tested at 2.4 gallons per minute (GPM) in tap water with less than 5% of the flow going through the resin. On recombination of the flows, nanobubble production was 3.95×10⁷ nanobubbles/mL.

### Example 2: Nanobubble Generation in an Aquarium

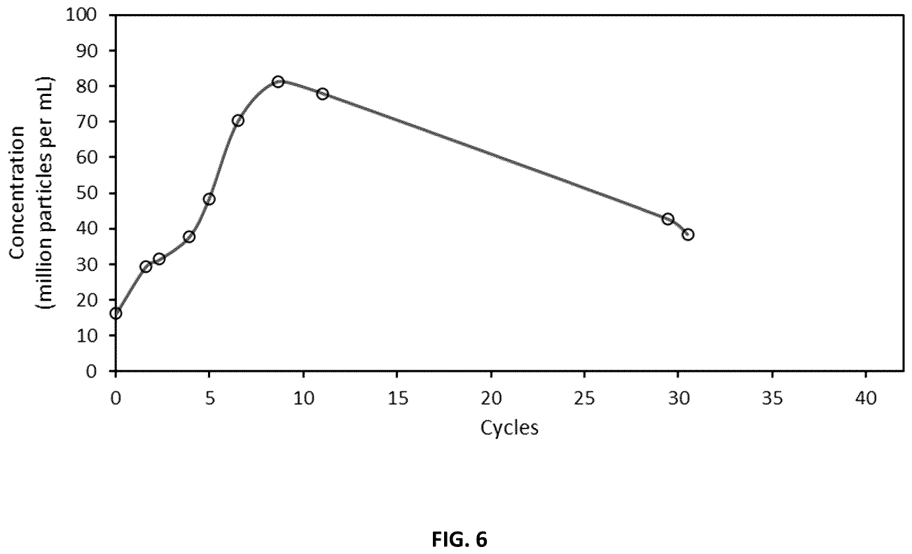

Nanobubble generation was also tested in a recirculating configuration in which the nanobubble generator recirculated a static volume of liquid. This configuration was used to generate nanobubbles in an aquarium. Nanobubble generation was tested at 0.7 GPM in tap water with less than 10% of the flow going through the resin. In this configuration, the high conductivity liquid stream included greater than 90% of the flow and the low conductivity liquid stream included less than 10% of the flow. The conductivity differential between the high conductivity liquid stream and the low conductivity liquid stream was less than 4 μS. As shown in FIG. 6, the concentration of nanobubbles fluctuates as the volume of water is recirculated through the nanobubble generator.

Taken together, these results demonstrate that the split-manipulate-recombine configuration in the nanobubble generators described herein can be used to produce high concentrations of nanobubbles in static and recirculating systems.

### Other Embodiments

It is to be understood that while the document has been described in conjunction with the detailed description thereof, the foregoing description is intended to illustrate and not limit the scope of the document. Other aspects, advantages, and modifications are within the scope of the following claims.

What is claimed is:

1. A nanobubble generator comprising:
(a) an inlet configured to receive a liquid stream comprising dissolved gas;
(b) means in communication with the liquid stream configured to manipulate the liquid stream to form a first liquid substream and a second liquid substream in which the solubility of gas in the first liquid substream is different from the solubility of gas in the second liquid substream;
(c) a mixer in communication with the first and second liquid substreams configured to combine the first and second liquid substreams to form a discharge stream comprising nanobubbles in a liquid carrier; and
(d) an outlet configured to discharge the discharge stream, wherein the discharge stream comprises at least 10⁶ nanobubbles per cm³.

2. The nanobubble generator of claim 1, wherein the first liquid substream and second liquid substream have different temperatures from each other.

3. The nanobubble generator of claim 1, wherein the first liquid substream and second liquid substream have different ionic conductivities from each other.

4. The nanobubble generator of claim 3, wherein the means in communication with the liquid stream comprises:
(a) a stream splitter in communication with the liquid stream configured to separate the liquid stream into a first liquid substream having an ionic conductivity and a second liquid substream having an ionic conductivity; and
(b) an ion exchange membrane, resin, or combination thereof in communication with the first liquid substream, the second liquid substream, or both configured to remove ions from the first liquid substream, the second liquid substream, or both to adjust the relative ionic conductivities of the first and second liquid substreams such that the ionic conductivity of the first liquid substream is different from the ionic conductivity of the second liquid substream.

5. The nanobubble generator of claim 3, wherein the means in communication with the liquid stream comprises a membrane configured to separate the liquid stream into a first liquid substream having an ionic conductivity and a second liquid substream having an ionic conductivity that is different from the ionic conductivity of the first liquid substream.

6. The nanobubble generator of claim 5, wherein the membrane is selected from the group consisting of an ultrafiltration membrane, a nanofiltration membrane, a reverse osmosis membrane, and combinations thereof.

7. The nanobubble generator of claim 3, wherein the means in communication with the liquid stream comprises:
(a) a stream splitter in communication with the liquid stream configured to separate the liquid stream into a first liquid substream having an ionic conductivity and a second liquid substream having an ionic conductivity; and
(b) a salt source in communication with the first liquid substream, the second liquid substream, or both configured to introduce salt into the first liquid substream, the second liquid substream, or both to adjust the relative ionic conductivities of the first and second liquid substreams such that the ionic conductivity of the first liquid substream is different from the ionic conductivity of the second liquid substream.

8. The nanobubble generator of claim 1, wherein the means in communication with the liquid stream comprises:
(a) a stream splitter in communication with the liquid stream configured to separate the liquid stream into a first liquid substream and a second liquid substream; and
(b) a source of a solubilty agent in communication with the first liquid substream, the second liquid substream, or both configured to introduce the solubility agent into the first liquid substream, the second liquid substream, or both.

9. The nanobubble generator of claim 8, wherein the solubility agent comprises one or more of a salt, an acid, a base, an organic additive, or a polymer.

10. An apparatus comprising:
(a) an aquarium; and
(b) the nanobubble generator of claim 1, configured to introduce the discharge stream comprising nanobubbles in a liquid carrier into the aquarium.

11. An apparatus comprising:
(a) an irrigation system; and
(b) the nanobubble generator of claim 1, configured to introduce the discharge stream comprising nanobubbles in a liquid carrier into the irrigation system.

12. A method for generating nanobubbles comprising:
(a) providing a liquid stream comprising dissolved gas;
(b) manipulating the liquid stream to form a first liquid substream and a second liquid substream in which the solubility of gas in the first liquid substream is different from the solubility of gas in the second liquid substream; and
(c) combining the first and second liquid substreams to form a discharge stream comprising nanobubbles in a liquid carrier,
wherein the discharge stream comprises at least 10⁶ nanobubbles per cm³.

13. The method of claim 12, wherein manipulating the liquid stream comprises manipulating the liquid stream such that the first liquid substream and second liquid substream have different temperatures, different ionic conductivities, or a combination thereof from each other.
